(19) United States
(12) Patent Application Publication
(10) Pub. No.: US 2016/0293124 A1
(43) Pub. Date: Oct. 6, 2016

(54) ARRAY SUBSTRATE, PIXEL DRIVING METHOD AND DISPLAY DEVICE

(71) Applicants: BOE TECHNOLOGY GROUP CO., LTD., Beijing (CN); CHENGDU BOE OPTOELECTRONICS TECHNOLOGY CO., LTD., Chengdu, Sichuan (CN)

(72) Inventors: Yanxia XIN, Beijing (CN); Seungyik PARK, Beijing (CN); Huiguang YANG, Beijing (CN)

(73) Assignees: BOE TECHNOLOGY GROUP CO., LTD., Beijing (CN); CHENGDU BOE OPTOELECTRONICS TECHNOLOGY CO., LTD., Chengdu, Sichuan (CN)

(21) Appl. No.: 14/778,045

(22) PCT Filed: Mar. 13, 2015
(86) PCT No.: PCT/CN2015/074149

§ 371 Date: Sep. 17, 2015

(30) Foreign Application Priority Data
Nov. 5, 2014 (CN) 201410638203.3

(51) Int. Cl. G09G 3/36; G02F 1/1362

(52) U.S. Cl. CPC G09G 3/3614; G09G 3/3685; G09G 3/3696; G02F 1/136286; G09G 2320/0209

(57) ABSTRACT

The present disclosure provides an array substrate, a pixel driving method and a display device. The array substrate includes scanning lines arranged in a plurality of rows and data lines arranged in a plurality of columns. The data line in each column includes a plurality of curved portions, each curved portion is arranged at a periphery of an aperture region of a corresponding pixel and includes an opening facing a row direction, and the openings of two adjacent curved portions face opposite directions. The pixels corresponding to the curved portions of the data line in each column are arranged in an identical column, and the curved portions of the data lines in an identical row include the openings facing an identical direction.

### CROSS-REFERENCE TO RELATED APPLICATION

The present application claims a priority of the Chinese patent application No.201410638203.3 filed on Nov. 5, 2014, which is incorporated herein by reference in its entirety.

### TECHNICAL FIELD

The present disclosure relates to the field of display technology, in particular to an array substrate, a pixel driving method and a display device.

### BACKGROUND

Liquid crystal molecules for a liquid crystal display screen have such a property as being easy to age when they are arranged at a fixed polarity, resulting in image deterioration. At this time, polarities of a data voltage related to a common voltage are inverted constantly, usually in a dot-inversion, column-inversion or row-inversion mode. The dot-inversion mode is of relatively large power consumption, so the latter two modes are usually adopted. For the column-inversion mode, the positive and negative polarities of the data voltage are inverted through subpixels corresponding to adjacent data lines on a column basis. However, this column-inversion mode may result in crosstalk and flickering.

### SUMMARY

An object of the present disclosure is to reduce the occurrence of crosstalk and flickering.

In one aspect, the present disclosure provides in one embodiment an array substrate, including scanning lines in a plurality of rows and data lines in a plurality of columns. The data line in each column includes a plurality of curved portions, each curved portion is arranged at a periphery of an aperture region of a corresponding pixel and includes an opening facing a row direction, and the openings of two adjacent curved portions face opposite directions. The pixels corresponding to the curved portions of the data line in each column are arranged in an identical column, and the curved portions of the data lines in an identical row include the openings facing an identical direction.

Alternatively, the data line in each column includes first portions arranged at both sides of pixels in a corresponding column and second portions each arranged between the aperture regions of two adjacent pixels in the corresponding column, the first portions include first side portions in odd-numbered rows and second side portions in even-numbered rows, and the first side portions and the second side portions are connected via the second portions to form the curved portions.

Alternatively, for the data line in an N^{th} column, each curved portion is arranged at a periphery of an aperture region of one of the pixels in an N^{th} or (N+1)^{th} column.

Alternatively, the first portion extends in a direction parallel to a column direction, and the second portion extends in a direction parallel to a row direction.

Alternatively, the first side portion of the data line in each column is connected to a gating switch for a pixel at a first side of the first side portion, and the second side portion of the data line in each column is connected to a gating switch for a pixel at a second side of the second side portion.

Alternatively, the first side portions and the second side portions of the data line in each column are connected to the gating switches for the pixels at the first side of the data line.

Alternatively, the first side portions and the second side portions of the data line in each column are connected to the gating switches for the pixels at the second side of the data line.

Alternatively, the first side portion of the data line in each column is connected to the gating switch for the pixel at a second side of the first side portion, and the second side portion of the data line in each column is connected to the gating switch for the pixel at a first side of the second side portion.

In another aspect, the present disclosure provides in one embodiment a pixel driving method for driving the above-mentioned array substrate, including a step of applying data voltages with opposite polarities onto two data lines in adjacent columns, respectively.

Alternatively, the pixel driving method further includes inverting the polarities of data voltage applied onto the data line in each column at a predetermined time period.

In yet another aspect, the present disclosure provides in one embodiment a display device including the abovementioned array substrate and a data driver integrated circuit. A data line in each column is connected to an output end of the data driver integrated circuit, and polarities of voltages from the output ends connected to two data lines in adjacent columns are opposite to each other.

According to the embodiments of the present disclosure, the polarities of the voltages applied to the data lines adjacent to the adjacent pixels in the row direction are opposite to each other, so it is able to make a balance between coupling voltages generated between the pixels and the data lines, thereby to remarkably reduce the occurrence of crosstalk and flickering.

### BRIEF DESCRIPTION OF THE DRAWINGS

FIG. 1 is a schematic view showing an array substrate according to the first embodiment of the present disclosure;

FIG. 2 is another schematic view showing the array substrate according to the second embodiment of the present disclosure; and

FIG. 3 is yet another schematic view showing the array substrate according to the third embodiment of the present disclosure.

### DETAILED DESCRIPTION

The present disclosure will be described hereinafter in conjunction with the drawings and embodiments. The following embodiments are for illustrative purposes only, but shall not be used to limit the scope of the present disclosure.

### First Embodiment

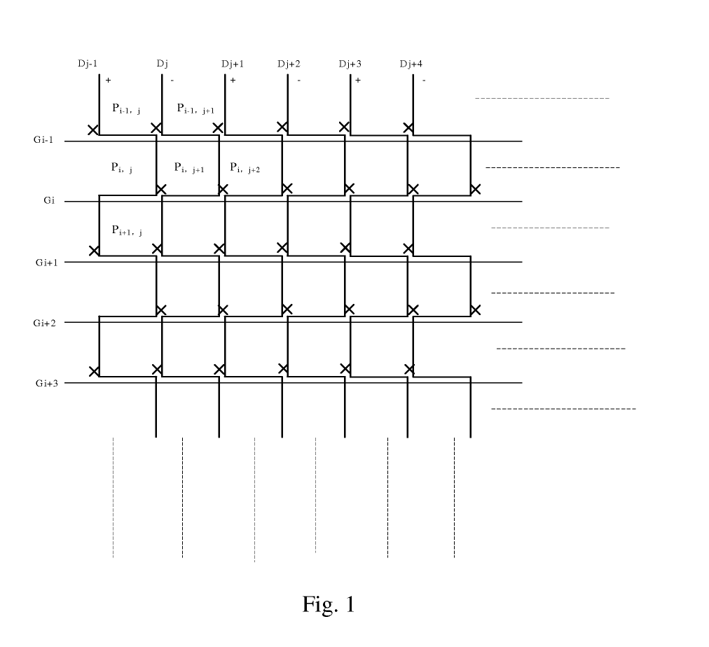

As shown in FIG. 1, the present disclosure provides in the first embodiment an array substrate, which includes scanning lines (Gi−1, Gi, Gi+1, Gi+2, . . . ) in a plurality of rows and data lines (Dj−1, Dj, Dj+1, Dj+2, . . . ) in a plurality of columns. A plurality of pixel regions (e.g., P_{i,j}, P_{i,j+1} and P_{i-1,j}) is defined by the scanning lines arranged in a row direction and the data lines arranged in a column direction. The data line Dj in any column includes first portions arranged at left and right sides of pixels in a (j+1)^{th} column and second portions each arranged between aperture regions of two adjacent pixels in the (j+1)^{th} column. The first portions include portions arranged at left sides of the pixels in odd-numbered rows and portions arranged at right sides of the pixels in even-numbered rows. The left-side portions and the right-side portions are connected via the second portions to form a plurality of curved portions. The left-side portions in the first portions of the data line Dj are connected to gating switches (represented by “X” in FIG. 1) for the pixels arranged at the left side (i.e., the pixels in the j^{th} column), so as to drive the pixels at the left side. The right-side portions in the first portions of the data line Dj are connected to grating switches for the pixels arranged at the right side (i.e., the pixels in a (j+2)^{th} column), so as to drive the pixels at the right side.

According to the array substrate in the first embodiment of the present disclosure, it is able to make a balance between polarities of voltages between the pixels on a liquid crystal display panel, thereby to remarkably reduce the occurrence of flickering and chromatic aberration. The principle of making a balance between the polarities of the voltages between the pixels on the liquid crystal display panel will be described hereinafter with reference to FIG. 1. As shown in FIG. 1, for a pixel P_{i,j} in an i^{th} row and a j^{th} column, the closest data line on the right is Dj−1, and for a pixel P_{i+1,j} in an (i+1)^{th} row and a j^{th} column, the closest data line on the right is Dj. During the actual application, when voltages with opposite polarities are applied onto the data lines Dj−1 and Dj, e.g., when a positive voltage is applied onto the data line Dj−1 and a negative voltage is applied onto the data line Dj, a pixel electrode in P_{i,j} is affected by the positive voltage while a pixel electrode in P_{i+1,j} is affected by the negative voltage, so the effects on the pixels P_{i,j} and P_{i+1,j} caused by the data lines are offset by each other. Identically, the effects on the pixels P_{i,j} and P_{i+1,j} caused by the data lines on the left may be offset by each other too. Hence, for any two adjacent pixels in the row direction, the effects on them caused by the data lines may be offset by each other, and as a result, it is able to make a balance between the polarities of the voltages between the pixels on the liquid crystal display panel, thereby to remarkably reduce the occurrence of crosstalk and flickering.

During the implementation, the first portion may extend in a direction parallel to the column direction, and the second portion may extend in a direction parallel to the row direction, so as to facilitate the manufacture thereof. During the actual application, the first portion may extend in a direction approximately parallel to the column direction, and at this time, it is also able to solve the above-mentioned technical problem. In addition, in this embodiment, the extension direction and the shape of the second portion may not be particularly defined, as long as it can connect the left-side portion and the right-side portion of the first portion and the normal display of the aperture region is not adversely affected.

It should be appreciated that, the above description is given in the first embodiment when the first portions of the data line in the odd-numbered rows are arranged at the left side of the corresponding column of the pixels and connected to the gating switches for the pixels on the left, and the first portions of the data line in the even-numbered rows are arranged at the right side of the corresponding column of the pixels and connected to the gating switches for the pixels on the right. However, during the actual application, the first portions of the data line in the even-numbered rows may be arranged at the left side of the corresponding column of the pixels and connected to the gating switches for the pixels on the left, and the first portions of the data line in the odd-numbered rows may be arranged at the right side of the corresponding column of the pixels and connected to the gating switches for the pixels on the right, and at this time, an identical effect may be achieved.

### Second Embodiment

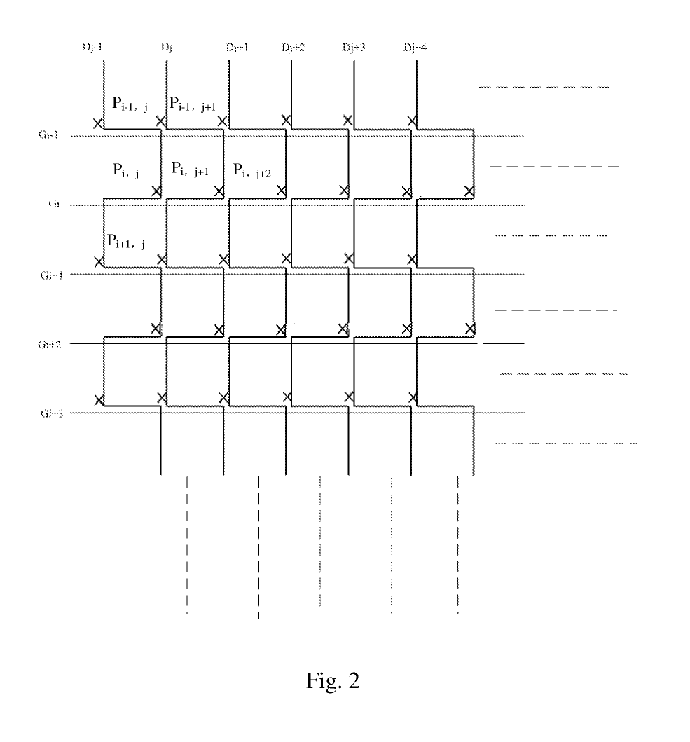

As shown in FIG. 2, the present disclosure further provides in the second embodiment an array substrate. Different from FIG. 1, for the array substrate in FIG. 2, the right-side portions of the first portions of the data line Dj are connected to the gating switches for the pixels on the left (i.e., the pixels in the (j+1)^{th} column). The array substrate in FIG. 2 may also be used to solve the above-mentioned technical problem, and the principle is similar to that mentioned in the first embodiment and thus will not be repeated herein.

It should be appreciated that, FIG. 2 merely shows the situation where the data line in each column is connected to the gating switches for the pixels on the left. However, during the actual application, the data line in each column may also be connected to the gating switches for the pixels on the right, i.e., for the data line Dj in any column, the left-side portions are connected to the gating switches for the pixels arranged at the right side of the left-side portions (i.e., the pixels in the (j+1)^{th} column), and the right-side portions are connected to the gating switches for the pixels arranged at the right side of the right-side portions (i.e., the pixels in an (j+2)^{th} column), and at this time, the same effect may be achieved.

### Third Embodiment

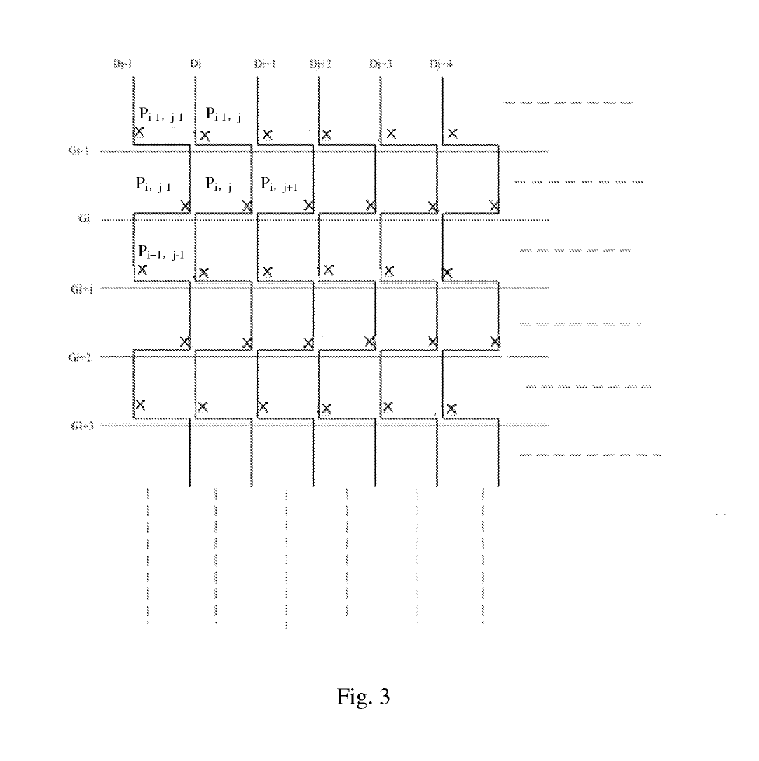

As shown in FIG. 3, the present disclosure further provides in the third embodiment an array substrate. Different from FIG. 1 or 2, for the array substrate in FIG. 3, the first portions of the data line Dj are arranged at both sides of the pixels in the j^{th} column. At this time, the left-side portions of the first portions of the data line Dj are connected to the gating switches (represented by “X” in FIG. 3) for the pixels on the right (i.e., the pixels in the j^{th} column), and the right-side portions of the first portions of the data line Dj are connected to the gating switches for the pixels on the left (i.e., the pixels in the j^{th} column). The array substrate in FIG. 3 may also be used to solve the above-mentioned technical problem, and the principle is similar to that mentioned in the first or second embodiment and thus will not be repeated herein.

The present disclosure further provides in one embodiment a pixel driving method for driving the above-mentioned array substrate, including a step of applying data voltages with opposite polarities onto data lines in two adjacent columns, respectively.

In FIGS. 1-3, a positive voltage may be applied onto the data lines in the odd-numbered columns and a negative voltage may be applied onto the data lines in the even-numbered columns. In this way, the polarities of the voltages applied to the data lines adjacent to the adjacent pixels in the row direction are opposite to each other, so it is able to make a balance between coupling voltages generated between the pixels and the adjacent data lines, thereby to remarkably reduce the occurrence of crosstalk and flickering.

The pixel driving method further includes inverting the polarities of data voltage applied onto the data line in each column at a predetermined time period. Here, the predetermined time period may be one frame, or half a frame, and it may be set in accordance with the practical need.

The present disclosure further provides in one embodiment a display device including the abovementioned array substrate and a data driver integrated circuit. A data line in each column is connected to an output end of the data driver integrated circuit, and polarities of voltages from the output ends connected to two data lines in adjacent columns are opposite to each other. Here, the display device may be any product or member having a displaying function, such as an electronic paper, a mobile phone, a flat-panel PC, a television, a display, a laptop PC, a digital photo frame or a navigator.

The above are merely the preferred embodiments of the present disclosure. It should be appreciated that, a person skilled in the art may make further modifications and improvements with departing from the principle of the present disclosure, and these modifications and improvements shall also fall within the scope of the present disclosure.

What is claimed is:

1. An array substrate, comprising scanning lines arranged in a plurality of rows and data lines arranged in a plurality of columns, wherein the data line in each column comprises a plurality of curved portions, each curved portion is arranged at a periphery of an aperture region of a corresponding pixel and comprises an opening facing a row direction, the openings of two adjacent curved portions face opposite directions, the pixels corresponding to the curved portions of the data line in each column are arranged in an identical column, and the curved portions of the data lines in an identical row comprise the openings facing an identical direction.

2. The array substrate according to claim 1, wherein the data line in each column comprises first portions arranged at both sides of pixels in a corresponding column and second portions each arranged between the aperture regions of two adjacent pixels in the corresponding column, the first portions comprise first side portions in odd-numbered rows and second side portions in even-numbered rows, and the first side portions and the second side portions are connected via the second portions to form the curved portions.

3. The array substrate according to claim 2, wherein for the data line in an N^{th} column, each curved portion is arranged at a periphery of an aperture region of one of the pixels in an N^{th} or (N+1)^{th} column.

4. The array substrate according to claim 2, wherein the first portion extends in a direction parallel to a column direction, and the second portion extends in a direction parallel to a row direction.

5. The array substrate according to claim 2, wherein the first side portion of the data line in each column is connected to a gating switch for a pixel at a first side of the first side portion, and the second side portion of the data line in each column is connected to a gating switch for a pixel at a second side of the second side portion.

6. The array substrate according to claim 2, wherein the first side portions and the second side portions of the data line in each column are connected to the gating switches for the pixels at the first side of the data line.

7. The array substrate according to claim 2, wherein the first side portions and the second side portions of the data line in each column are connected to the gating switches for the pixels at the second side of the data line.

8. The array substrate according to claim 2, wherein the first side portion of the data line in each column is connected to the gating switch for the pixel at a second side of the first side portion, and the second side portion of the data line in each column is connected to the gating switch for the pixel at a first side of the second side portion.

9. A pixel driving method for driving the array substrate according to claim 1, comprising a step of applying data voltages with opposite polarities onto two data lines in adjacent columns, respectively.

10. The pixel driving method according to claim 9, further comprising inverting the polarities of data voltage applied onto the data line in each column at a predetermined time period.

11. A display device, comprising the array substrate according to claim 1, and a data driver integrated circuit, wherein a data line in each column is connected to an output end of the data driver integrated circuit, and polarities of voltages from the output ends connected to two data lines in adjacent columns are opposite to each other.

12. The display device according to claim 11, wherein the data line in each column comprises first portions arranged at both sides of pixels in a corresponding column and second portions each arranged between the aperture regions of two adjacent pixels in the corresponding column, the first portions comprise first side portions in odd-numbered rows and second side portions in even-numbered rows, and the first side portions and the second side portions are connected via the second portions to form the curved portions.

13. The display device according to claim 12, wherein for the data line in an N^{th} column, each curved portion is arranged at a periphery of an aperture region of one of the pixels in an N^{th} or (N+1)^{th} column.

14. The display device according to claim 12, wherein the first portion extends in a direction parallel to a column direction, and the second portion extends in a direction parallel to a row direction.

15. The display device according to claim 12, wherein the first side portion of the data line in each column is connected to a gating switch for a pixel at a first side of the first side portion, and the second side portion of the data line in each column is connected to a gating switch for a pixel at a second side of the second side portion.

16. The display device according to claim 12, wherein the first side portions and the second side portions of the data line in each column are connected to the gating switches for the pixels at the first side of the data line.

17. The display device according to claim 12, wherein the first side portions and the second side portions of the data line in each column are connected to the gating switches for the pixels at the second side of the data line.

18. The display device according to claim 12, wherein the first side portion of the data line in each column is connected to the gating switch for the pixel at a second side of the first side portion, and the second side portion of the data line in each column is connected to the gating switch for the pixel at a first side of the second side portion.
